(19) United States
(12) Patent Application Publication
(10) Pub. No.: US 2006/0102099 A1
(43) Pub. Date: May 18, 2006

(54) Polymeric dog bone

(76) Inventor: Philip L. Edwards, Grosse Pointe Farms, MI (US)

Correspondence Address: Douglas Sprinkle of Gifford, Krass, Groh,;Sprinkle, Anderson & Citkowski, P.C., 2701 Troy Center Drive, Suite 300, P.O. Box 7021, Troy, MI, 48007-7021, US

(21) Appl. No.: 10/987,129

(22) Filed: Nov. 12, 2004

(51) Int. Cl. A01K 29/00

(52) U.S. Cl. 119/710

(57) ABSTRACT

In at least one embodiment, the present invention relates to a polymeric dog bone comprising an elongated central body portion having an end portion. At least one end member extends from the end portion of the central body portion. In at least one embodiment, the end member has a first surface, a second surface, a plurality of first-shaped features located on the first surface, and a plurality of second-shaped features having a different shape than the first-shaped features located on the second surface.

### BACKGROUND OF THE INVENTION

1. Field of the Invention

The present invention relates to a polymeric dog bone that has one or more dental care features.

2. Background Art

Chewable pet toys are commonly used to strengthen a dog's teeth and massage its gums. Chewable pet toys can be made of natural materials such as rawhide or synthetic polymeric materials such as rubber and plastic. These types of pet toys are well known in the art.

Chewable toys that are made of natural materials can be beneficial because they have an odor and taste that can be pleasing to the dog. Natural toys can also have a beneficial effect on the dog's teeth and gums. When a dog chews a natural toy, the toy bends and tears exposing various surfaces and edges against which the dog's teeth can scrape. The surfaces and edges scrape against the dog's teeth, removing plaque and tartar. An additional benefit of natural toys is that the hardness and flexibility can vary along the toy. This is because the natural material can absorb the dog's saliva. Wet portions of a chew toy tend to exhibit greater flexibility than dry portions. The variable flexural chew surfaces are pleasing to the dog and promotes increased chewing.

There are, however, several drawbacks to natural chew toys. Small pieces that can relatively easily become extracted from the chew toy can pose a choking hazard to the dog. Natural chew toys may be quickly destroyed and consumed, especially for large dogs and hard chewers. Chew toys that are fabricated from synthetic materials tend not to exhibit these problems.

U.S. Pat. No. 4,513,014 generally discloses a molded chewable elastomeric dog bone. The dog bone is fabricated from a polyurethane that is characterized by moderate hardness, resilient deformability, large tensile strength and resistance to shearing. The polyurethane dog bone comprises a surface migrating flavoring that is pleasing to a dog.

U.S. Pat. No. 5,263,436 generally discloses a rigid elastomeric bone-shaped chew toy for a dog. The bone comprises sharp uniform spikes distributed over its entire surface. As the dog chews on the toy, the tips of the spikes contact various surfaces of the dog's teeth and gums. A shortcoming of this design is that the sharp spikes may be irritating to a dog's teeth and gums. Additionally, the only cleaning occurs between the tip of the spike and the surface of a dog's teeth. The contact area between the tip of a spike and a dog's teeth is small and therefore cleaning may be inefficient. Further, all of the spikes exhibit the same hardness and rigidity. The spikes do not provide enough tactile variety to satisfy the dog's attention.

There is a need for a polymeric chewable dog bone that is flexible and relatively durable that includes dental cleaning that should be tactily pleasing to the dog.

### SUMMARY OF THE INVENTION

The present invention generally relates to a polymeric dog bone having dental care features. According to one aspect of the invention, the polymeric dog bone includes an elongated body portion and an end member that extends from the elongated body portion. The end member includes at least two surfaces. One of the surfaces includes a plurality of first-shaped dental features. Another of the surfaces includes a plurality of second-shaped dental features that are a different shape than the first-shaped dental features.

According to another aspect of the invention, the polymeric dog bone includes an elongated central body portion that has a first end and a second end. The first end is oriented substantially along a first axis and the second end is oriented substantially along a second axis. The dog bone further includes a pair of generally V-shaped portions that extend respectively from the first and second ends. Each of the V-shaped portions includes a top surface, a bottom surface, and a pair of opposed side surfaces. Each of the top surfaces includes a plurality of first-shaped dental features and each of the bottom surfaces includes a plurality of second-shaped dental features. The first-shaped dental features have a different shape than the second-shaped features.

According to another aspect of the invention, the polymeric dog bone includes an elongated central body portion that has a first end and a second end. The first end is oriented substantially along a first axis and the second end is oriented substantially along a second axis. The dog bone further includes a pair of end members that extend respectively from the first and second ends of the central body portion. Each end member includes a first surface and a second surface that is generally opposed to its respective first surface. Each of the first surfaces extends away from the corresponding body axis at a first angle and each of the second surfaces extends away from the corresponding body axis at a second angle. The first angle is different than the second angle. Each of the first surfaces includes a plurality of first-shaped dental features.

According to yet another aspect of the invention, the polymeric dog bone includes an elongated central body portion with an end portion. The dog bone further includes an end member that extends from the end portion. The end member includes at least two surfaces. One of the surfaces includes a plurality of first-shaped dental features and another of the surfaces includes a plurality of second-shaped dental features. The first-shaped feature can be more flexible than the second-shaped feature.

According to another aspect of the invention, the first-shaped dental feature may include a projecting member and a recessed portion. The projecting member may extend about the recessed portion. The projecting member may include a base portion and a distal portion. The first-shaped feature may include a flexible distal cleaning surface.

According to another aspect of the invention, the second-shaped dental feature may include a projection. The projection may include a plurality of laterally-disposed ribs. The ribs may extend radially from an axis that is defined by the projection. The second-shaped feature may include a lateral cleaning surface.

The dog bone may further include a variety of features each with a differing hardness and flexibility. The dog bone may further yet include features that are capable of wide surface contact with the dog's teeth. The features may be capable of reaching and cleaning a large surface area of the dog's teeth. The dog bone may include features that are capable of contacting the dog's teeth from many different angles.

Other aspects and benefits should become apparent from the detailed description and drawings.

### BRIEF DESCRIPTION OF THE DRAWINGS

FIG. 1 is a top view of a molded dog bone made in accordance with at least one aspect of the present invention;

FIG. 2 is a side view of the molded dog bone shown in FIG. 1;

FIG. 3 is an enlarged perspective view of a portion of the dog bone shown in FIG. 1; and

FIG. 4 is similar to FIG. 3 illustrating another portion of the dog bone shown in FIG. 1.

### DETAILED DESCRIPTION OF THE PREFERRED EMBODIMENTS

As required, detailed embodiments of the present invention are disclosed herein. However, it is to be understood that the disclosed embodiments are merely exemplary of the invention that may be embodied in various alternative forms. The figures are not necessarily to scale; some features may be exaggerated or minimized to show details of particular components. Therefore, specific structural or functional details disclosed herein are not to be interpreted as limiting, but merely as a representative basis for the claims and/or a representative basis for teaching one skilled in the art to variously employ the present invention.

Moreover, except for otherwise expressly indicated, all numeral quantities in this description and in the claims indicating amounts or conditions are to be understood as modified by the word “about” in describing the broader scope of the invention. Practice within the numerical range as stated is generally preferred. Also, unless expressly stated to the contrary, percents, “parts of,” and ratio values are by weight, and the description of a group or class of materials as suitable or preferred for a given purpose in connection with the invention implies that mixtures of any two or more members of the group or class may be equally suitable and preferred.

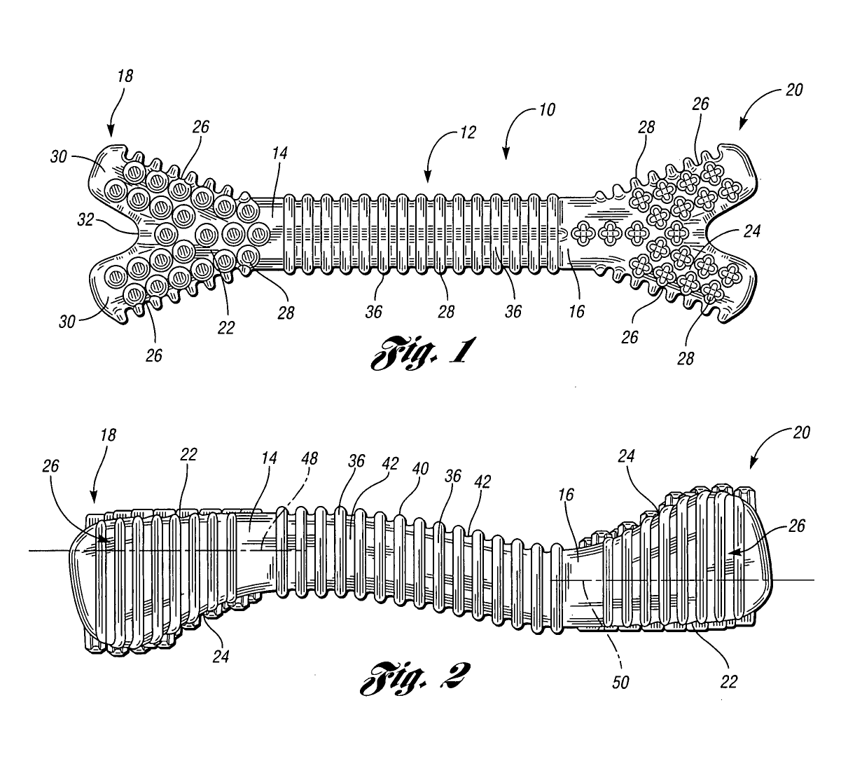

FIG. 1 generally illustrates a molded dog bone 10 made in accordance with an embodiment of the present invention. While being illustrated and described as a dog bone for a dog's use, it should be understood that the principals of this invention can be adapted for other animal bones, such as bones for cats and ferrets.

The dog bone 10 shown in FIG. 1 comprises an elongated central body portion 12. The elongated central body portion 12 includes first and second end portions 14, 16. The molded dog bone further includes a pair of end members 18, 20 that extend from a respective end portion 14, 16. Each end member 18,20 includes a first surface 22, a second surface 24 that is opposite the first surface, and a pair of side surfaces 26, as shown in FIG. 2. Each side surface 26 is generally transverse to the first surface 22 and the second surface 24. Each side surface 26 extends between and connects the first surface 22 and the second surface 24. The molded dog bone includes a plurality of dental care features 28.

The molded dog bone 10 may be produced by any suitable manufacturing process generally known in the art. For example, the molded dog bone 10 may be produced by conventional injection molding. The molded dog bone 10 may comprise polyurethane rubber. Alternately, the molded dog bone 10 may comprise Nylon or any other suitable material generally known in the art.

As depicted in FIG. 1, the side surfaces 26 may extend at an angle away from the elongated central body portion 12 forming a flared end member 18, 20. The flared end member 18, 20 can allow the dog to grip the bone 10 between crossed paws. Additionally, when the side surfaces 26 extend at an angle, the end member can be angled at a position in contact with the dog's gum line and under its lips while the dog chews.

In an embodiment of the invention, as shown in FIG. 1, each end member 18, 20 is generally V-shaped. In this embodiment, the end members 18,20 comprise a pair of chew extensions 30 that flare endwise with the central body portion 12. Chew extensions 30 are separated by a notch 32. The notch 32 provides flexibility to the end member 18, 20. Chew extensions 30 can be gripped and chewed individually, especially in the mouth of a comparatively small dog. Alternately, the chew extensions 30 may be flexed towards one another by virtue of notch 32.

As shown in FIGS. 1 and 2, the central body portion 12 includes a plurality of circumferential ribs 36. Circumferential ribs 36 are arranged longitudinally with the elongated central body portion 12. Circumferential ribs 36 project from the surface of the dog bone 10 and include a distal surface 40. In at least one embodiment, the cross-section of a circumferential rib 36 decreases radially towards the distal surface 40. In at least one embodiment, the ribs 36 may independently have a thickness of 0.5-5.0 mm and a height of 1.0-10 mm. In yet another embodiment, the ribs 36 may independently have a thickness of 0.75-3.8 mm and a height of 1.5-7.6 mm.

Circumferential ribs 36 are longitudinally spaced from one another, defining circumferential grooves 42 therebetween. In at least one embodiment, the grooves 42 may independently have a thickness of 0.5-5.0 mm and a depth of 0.75-7.5 mm. In yet another embodiment, the grooves 42 may independently have a thickness of 0.75-3.8 mm and a depth of 1.25-7.5 mm. Circumferential ribs 36 and circumferential grooves 42 serve several beneficial purposes. First, the ribs 36 and grooves 42 create an “accordion” effect. This can result in increased flexibility in the elongated central body portion 12. Circumferential ribs 36 can also provide a dental cleaning function. When a dog chews the elongated central body portion 12, the dog's teeth can scrape along the distal surfaces 40 of the circumferential ribs 36. Plaque that has built up on the dog's teeth may be removed through repetitive chewing. Additionally, the distal surfaces 40 can massage the dog's gums when the dog chews the toy.

As shown in FIG. 2, the first end portion 14 is oriented generally along a first axis 48 and the second end portion 16 is oriented generally along a second axis 50. The first axis 48 and the second axis 50 may be separated and generally parallel as shown in FIG. 2. Alternately, the first axis 48 and the second axis 50 may be collinear. The first axis 48 and the second axis 50 may project at an angle to one another. The central body portion 12 may extend linearly at an angle between first and second end portions 14, 16. Alternately, the central body portion 12 may follow any linear or compound curvilinear path between the end portions.

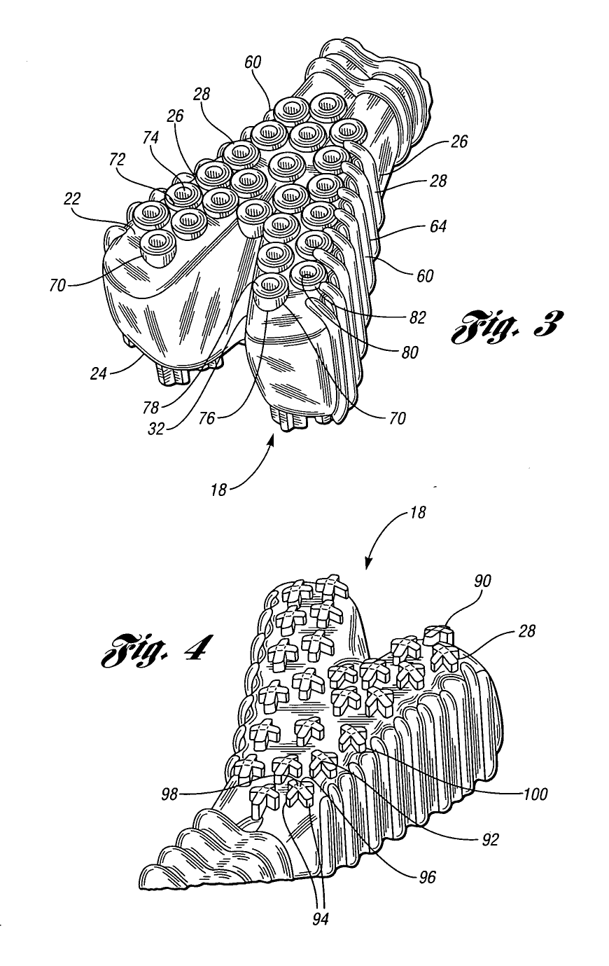

As shown in FIG. 2, the first surface 22 of an end member 18, 20 extends at a first angle from the corresponding end axis 48, 50 and the second surface 24 extends at a second angle from the corresponding end axis 48, 50. The first angle is different than the second angle. The first surface 22 also has a different shape than the second surface 24. The first surface 22 is generally planar while the second surface 24 is generally arcuate. By providing surfaces with multiple angles and shapes, the dog bone can have beneficial cleaning properties. This is because dental cleaning features that are disposed on the surfaces of end members 18,20 project from the bone 10 from multiple angles and therefore can contact the dog's teeth from multiple angles. Furthermore, as shown in the embodiment illustrated in FIG. 2, due to the shapes and angles relative to surfaces 22 and 24, side surfaces 26 tend to increase in length as they extend further from respective end portions 14 and 16. According to the embodiment shown in FIG. 3, bone 20 does not lie flat on a support surface, e.g. a floor, thus enabling a dog to reach between the support surface and bone 20 to pick up bone 20 to begin utilization of bone 20.

As shown in FIG. 3, the side surfaces 26 of the end members 18, 20 include a plurality of dental care features 28. The dental care features 28 include a plurality of rib projections 60. A rib projection 60 includes a distal surface 64. In at least one embodiment, the thickness of a rib projection 60 decreases in cross-section in the direction of the distal surface 64. The rib projection 60 extends along the side surface 26 between the first surface 22 and the second surface 24. In at least one embodiment, the ribs 60 have similar dimensions to ribs 36. In other embodiments, rib projections 60 can project away from the surface of molded dog bone 18 a greater distance than that of ribs 36, thereby providing additional cleanability to rib projections 60.

The rib projections 60 can serve a dental care function. When the dog chews on an end members 18, 20, the dog's teeth can come into contact with the distal surface 64 of the rib projections 60. Persistent chewing can result in repetitive scraping of the teeth against the distal surface 64, which can result in plaque removal.

As shown in FIG. 3, the first surface 22 of end member 18, 20 includes a plurality of dental care features 28. Dental care features 28 can include a first geometric feature 70. In at least one embodiment, the first geometric feature 70 includes a projecting portion 72 and a recessed portion 74. The projecting portion 72 includes a base portion 76 and a distal surface 78. The projecting portion 72 further includes generally opposed lateral surfaces 80 and 82. The projecting portion 72 defines a thin wall about the recessed portion 74. The recessed portion 74 is defined generally by lateral surface 80. The projecting portion 72 is flexible by virtue of the thin wall.

The first geometric feature 70 includes a distal cleaning surface 78. When the dog chews on the bone, the mesial surface of its teeth can come into contact with the distal surface 78 of the projecting portion 72. The flexible projection can cause the distal surface 78 to deform and conform to the dog's teeth like the bristles of a toothbrush. As the dog chews, the distal surface can scrape the teeth, removing any built-up plaque.

In at least one embodiment, the first geometric feature 70 may be generally O-shaped. The first geometric feature 70 may also be generally D-shaped. Similarly, the first geometric feature may be in the shape of any outlined geometric shape within the spirit and purpose of the invention.

FIG. 4 illustrates another dental cleaning feature 28 according to the invention. The second dental cleaning feature 28 comprises a second geometric feature 90 that includes a projecting member 92. The projecting member 92 includes a plurality of ribs 94 extending radially from an axis 96 that is defined by a focal projection 98. The second geometric feature 90 includes a lateral cleaning surface 100. The second geometric feature 90 has flexural properties that are different than the first geometric feature 70 by virtue of its shape and dimensions. The second geometric feature 90 is generally less flexible than the first geometric feature 70. The second geometric feature 90 may include four ribs 94 in which case it would be generally X-shaped. Alternatively, the second geometric feature 90 may include three ribs 94 and have a generally triangular and/or Y-shape. Further, the second geometric feature 90 may include two ribs and be generally V-shaped and/or T-shaped.

The second geometric feature is designed to probe between a dog's teeth. The focal projection 98 is relatively rigid and the ribs 94 are relatively flexible. The ribs can twist and turn, causing a brushing action that is beneficial for removing plaque between the dog's teeth and massage gums for dental health.

In at least one embodiment, the first cleaning feature 70, i.e., the projecting portion 72, has a height from base 76 to distal surface 72 of 0.75-3.8 mm, in other embodiments of 1.25-2.8 mm, and in yet other embodiments of 1.65-2.30 mm. Also, in at least one embodiment, the wall thickness, i.e., the distance between opposing surfaces 80 and 82 of the first feature 70 is 0.25-2.0 mm, in other embodiments is 0.50-1.5 mm, and in yet other embodiments is 0.750-1.14 mm.

In certain embodiments, when the first feature 70 has an inner diameter, i.e., the diameter defined by surface 80, and an outer diameter, i.e., the surface defined by surface 82, the inner and outer diameters may respectively be, in millimeters:

| | Inner Diameter | Outer Diameter |
|---|---|---|
| one embodiment | 0.75-3.81 | .25-5.1 |
| another embodiment | 1.0-2.8 | 2.8-4.7 |
| yet another embodiment | 1.25-2.5 | 2.9-4.3 |

In certain embodiments, the second cleaning feature 90 is taller than the first cleaning feature 70. In at least one embodiment, the second cleaning feature 90, i.e., the ribs 94 and projecting member 92, has a height of 1.5-5.1 mm, in other embodiments of 1.9-3.8 mm, and in yet other embodiments of 2.6-3.175 mm. Also, in at least one embodiment, the wall thickness of the second feature ribs 94 and projecting members 92 each independently are 0.25-2.0 mm, in other embodiments from 0.381-1.9 mm, and in yet other embodiments from 0.50-1.5 mm. Furthermore, in at least one embodiment, the distance the ribs 94 extend radially from the projecting member is 0.25-2.3 mm, in other embodiments 0.50-2.0 mm, and in yet other embodiments 0.750-1.8 mm.

Further embodiments will have smaller dimensions for smaller dogs and larger dimensions for even larger dogs.

While embodiments of the invention have been illustrated and described, it is not intended that these embodiments illustrate and describe all possible forms of the invention. For example, internal flavoring, such as beef or chicken, may be distributed throughout the bone 10, via introduction into the polymeric matrix material used to form the bone, to provide the bone with a desirable taste to the animal. Rather, the words used in the specification are words of description rather than limitation, and it is understood that various changes may be made without departing from the spirit and scope of the invention.

1-13. (canceled)

14. A polymeric dog bone comprising:
an elongated central body portion having a first end oriented substantially along a first axis and a second end oriented substantially along a second axis;
a first generally V-shaped portion extends from the first end; and
a second generally V-shaped portion extending from the second end, each of the generally V-shaped portions including a top surface, a bottom surface, and a pair of side surfaces;
wherein each top surface includes a plurality of first-shaped features and each bottom surface includes a plurality of second-shaped features having a different shape than the first-shaped features.

15. The polymeric dog bone of claim 14 wherein the first-shaped feature includes a projecting member extending about a recessed portion, wherein the projecting member has a base and a distal surface.

16. The polymeric dog bone of claim 15 wherein the first shaped feature is generally “O”-shaped.

17. The polymeric dog bone of claim 14 wherein the second-shaped feature includes a first linear projection having a base and a distal surface, and a second linear projection intersecting with the first linear projection and having a base and a distal surface.

18. The polymeric dog bone of claim 16, wherein the second-shaped feature is generally “X”-shaped.

19. The polymeric dog bone of claim 14 wherein the first axis and second axis are collinear.

20. The polymeric dog bone of claim 14 wherein the first axis and the second axis are spaced.

21. The polymeric dog bone of claim 14 wherein the central body portion extends at an angle between the first and second ends.

22-27. (canceled)
